(19) United States
(12) Patent Application Publication
(10) Pub. No.: US 2018/0107157 A1
(43) Pub. Date: Apr. 19, 2018

(54) MULTIFUNCTIONAL OPTICAL ELEMENT AND METHOD USING MULTIPLE LIGHT SCATTERING

(71) Applicant: Korea Advanced Institute of Science and Technology, Daejeon (KR)

(72) Inventors: YongKeun Park, Daejeon (KR); Jongchan Park, Daejeon (KR)

(73) Assignee: Korea Advanced Institute of Science and Technology, Daejeon (KR)

(21) Appl. No.: 15/787,560

(22) Filed: Oct. 18, 2017

(30) Foreign Application Priority Data
Oct. 19, 2016 (KR) 10-2016-0135741

(51) Int. Cl. G03H 1/04; G03H 1/02; G02F 1/01

(52) U.S. Cl. CPC G03H 1/04; G03H 1/02; G03H 2210/12; G03H 2001/0204; G03H 2210/11; G02F 1/01

(57) ABSTRACT

Disclosed herein are a multifunctional optical element and method using multiple light scattering. An optical control method using multiple light scattering may include the steps of splitting coherent light into a signal beam and a reference beam, controlling the wavefront of the signal beam, forming an interference pattern by making the signal beam having the controlled wavefront and the reference beam incident on photorefractive materials, recording the interference pattern on the photorefractive materials, reconstructing the signal beam having the controlled wavefront by the interference pattern by radiating the reference beam to the photorefractive materials on which the interference pattern has been recorded again, and controlling the properties of light passing through complex media based on multiple light scattering generated by the complex media as the reconstructed signal beam is incident on the complex media.

### BACKGROUND OF THE INVENTION

1. Technical Field

The present invention relates to a technology for controlling the optical properties (e.g., phase, amplitude, wavelength and polarization) of light by controlling the wavefront of the light incident on a medium.

2. Description of the Related Art

To produce an optical element capable of controlling the optical properties of light is a very important problem in all of fields in which light is used.

The optical element is used in the whole industry, such as a microscope, an endoscope and a photolithography apparatus, and is used almost everywhere of daily life, such as glasses, a lens and a projector.

In a conventional technology, the optical properties of light is controlled by designing the optical structure of a medium forming an optical element and fabricating the medium using a method, such as etching, polishing and/or micro-processing. As described above, to implement an optical element by designing and fabricating an optical structure requires a lot of time so as to produce a desired optical element, and results in a great computational load and a high manufacturing cost.

For example, a lens and a mirror are optical elements using a simple optical phenomenon, such as the refraction and reflection of light. The lens and the mirror can be easily designed and fabricated, but the ability by which the optical element can control light is limited.

FIG. 1 is a diagram showing the structure of a conventional optical element.

In FIG. 1, the optical element 110 is an optical element using an optical lens 101. The optical element 110 controls the properties of light using the refraction of the optical lens 110. The optical element 120 is a diffractive optical element (DOE) and uses the diffraction of light. The DOE can control light more complex than that of an optical lens and mirror, but the design and fabrication of the DOE are difficult.

Recently, various types of metasurfaces and metamaterials have been developed. The metasurfaces and the metamaterials are ideal concepts which can use all the parts of a wave equation, but can be very limitedly implemented because the design and fabrication thereof are very difficult. That is, the metasurfaces and the metamaterials can be experimentally implemented, but cannot be practically applied.

Accordingly, there is a need for a technology for controlling various optical properties of light at low costs without the design and fabrication process of an optical medium.

Korean Patent Application Publication No. 10-2009-0111786 discloses a technology for analyzing the wavefront of an optical beam, that is, the focus of an optical lens, from a source based on phase grating.

### PRIOR ART DOCUMENT

### Non-Patent Document

Cui, M. Parallel Wavefront Optimization Method for Focusing Light Through Random Scattering Media, Opt. Lett. 2011, 36, 870-872.

### SUMMARY OF THE INVENTION

An object of the present invention is to control the optical properties of light transmitted and reflected by complex media by controlling the wavefront of the light incident on the complex media in which multiple light scattering is generated.

Furthermore, another object of the present invention is to record a controlled wavefront, specifically, an interference pattern generated by light having the controlled wavefront on photorefractive materials and to subsequently semi-permanently reconstruct light having the controlled wavefront based on the recorded interference pattern.

An optical control method using multiple light scattering may include the steps of splitting coherent light into a signal beam and a reference beam, controlling the wavefront of the signal beam, forming an interference pattern by making the signal beam having the controlled wavefront and the reference beam incident on photorefractive materials, recording the interference pattern on the photorefractive materials, reconstructing the signal beam having the controlled wavefront by the interference pattern by radiating the reference beam to the photorefractive materials on which the interference pattern has been recorded again, and controlling the properties of light passing through complex media based on multiple light scattering generated by the complex media as the reconstructed signal beam is incident on the complex media.

In accordance with one aspect, the step of controlling the wavefront of the signal beam may include the steps of controlling at least one of the phase and amplitude of the signal beam incident on the photorefractive materials using a wavefront controller, making the signal beam at least one of whose phase and amplitude has been controlled incident on the photorefractive materials, making a signal beam passing through the photorefractive materials incident on the complex media, and performing wavefront optimization by measuring information of light output through the complex media.

In accordance with another aspect, in the step of forming the interference pattern, after the signal beam whose wavefront has been optimized and the reference beam illuminate the photorefractive materials with strong intensity of predetermined reference intensity or more and pass through a beam splitter, if a path difference between the signal beam and the reference beam met again in the photorefractive materials corresponds to a predefined coherence length or less, the signal beam and the reference beam may interfere with each other in the photorefractive materials to form the interference pattern.

In accordance with yet another aspect, while the optimization of the wavefront of the signal beam is performed, the reference beam may be blocked from being incident on the photorefractive materials.

In accordance with yet another aspect, the step of reconstructing the signal beam having the controlled wavefront may include the steps of blocking the signal beam from being incident on the photorefractive materials and reconstructing the signal beam having the controlled wavefront as the reference beam which has illuminated the photorefractive materials on which the interference pattern has been recorded again is diffracted or scattered by the interference pattern.

In accordance with yet another aspect, the interference pattern may be formed in the photorefractive materials as the reference beam is incident on the photorefractive materials after passing through a single mode fiber (SMF).

In accordance with yet another aspect, the step of controlling the properties of the light passing through the complex media may include controlling the amplitude, phase, wavelength and polarization of the light passing through the complex media by controlling at least one of the phase and amplitude of the light incident on the complex media.

In accordance with yet another aspect, the step of recording the interference pattern on the photorefractive materials may include performing a UV cure by radiating ultraviolet rays to the photorefractive materials on which the interference pattern has been recorded.

An optical element using multiple light scattering may include a wavefront controller configured to control the wavefront of a signal beam split from coherent light, photorefractive materials on which the signal beam having the controlled wavefront and a reference beam split from the coherent light are incident to form an interference pattern and on which the formed interference pattern is recorded, complex media on which the signal beam having the controlled wavefront reconstructed as the reference beam illuminates the photorefractive materials on which the interference pattern has been recorded again is incident, and a measuring unit configured to control and measure properties of light passing through the complex media based on multiple light scattering generated by the complex media.

In accordance with one aspect, the wavefront controller may change at least one of the phase and amplitude of the signal beam incident on the photorefractive materials, and may make the signal beam at least one of whose phase and amplitude has been changed incident on the photorefractive materials. The measuring unit may perform wavefront optimization by measuring information of light output after a signal beam passing through the photorefractive materials passes through the complex media.

In accordance with another aspect, the interference pattern may be formed as the signal beam and the reference beam interfere with each other in the photorefractive materials if a path difference between the signal beam and the reference beam met again in the photorefractive materials corresponds to a predefined coherence length or less after the signal beam whose wavefront has been optimized and the reference beam illuminate the photorefractive materials with strong intensity of predetermined reference intensity or more and pass through a beam splitter.

In accordance with yet another aspect, the optical element may further include a light source configured to emit the coherent light and a beam splitter configured to split the coherent light into the signal beam and the reference beam.

In accordance with yet another aspect, the beam splitter may block the reference beam from being incident on the photorefractive materials while optimization is performed on the wavefront of the signal beam.

In accordance with yet another aspect, the optical element may further include a shutter configured to block the signal beam from being incident on the photorefractive materials after the interference pattern is recorded on the photorefractive materials.

In accordance with yet another aspect, the photorefractive materials may reconstruct the signal beam having the controlled wavefront as the reference beam illuminated from the beam splitter is diffracted or scattered by the interference pattern, and the shutter may be disposed between the wavefront controller and the photorefractive materials.

In accordance with yet another aspect, the optical element may further include a single mode fiber (SMF) configured to transmit the reference beam split by a beam splitter. The reference beam passing through the SMF may be incident on the photorefractive materials.

In accordance with yet another aspect, the amplitude, phase, wavelength and polarization of light output through the complex media may be controlled as at least one of the phase and amplitude of the light incident on the complex media is controlled through the wavefront controller.

In accordance with yet another aspect, a UV cure for radiating ultraviolet rays to the photorefractive materials on which the interference pattern has been recorded may be performed.

In accordance with yet another aspect, the complex media is disposed between the photorefractive materials and the measuring unit, and includes a holographic diffuser.

The wavefront controller may include at least one of a spatial light modulator (SLM), a deformable mirror device and a dynamic mirror device.

In accordance with yet another aspect, as the signal beam having an optimized wavefront passes through the complex media, the transmitted beam may indicate a predefined desired optical field. As a signal beam having a not-optimized wavefront passes through the complex media, the transmitted beam may indicate a speckle pattern having a spatio-temporally random intensity distribution.

A scattering optical element may include photorefractive materials on which an interference pattern formed based on light having a wavefront controlled through wavefront optimization is recorded and complex media on which light radiated to the photorefractive materials and the light having the controlled wavefront generated based on the interference pattern are incident and configured to transmit or reflect the incident light. The light incident on the complex media may generate multiple light scattering controlled by the complex media, and the wavefront of the multiple-scattered light may be controlled so that the wavefront indicates a predefined desired optical field.

### BRIEF DESCRIPTION OF THE DRAWINGS

FIG. 1 is a diagram showing the structure of a conventional optical element.

FIG. 2 is a block diagram showing the internal configuration of an optical element using multiple light scattering in accordance with an embodiment of the present invention.

FIG. 3 is a flowchart showing a method of controlling the optical properties of light using multiple light scattering in the optical element in accordance with an embodiment of the present invention.

FIG. 4 is a diagram provided to describe an operation of controlling the properties of light using photorefractive materials on which a controlled wavefront has been recorded and complex media in accordance with an embodiment of the present invention.

FIG. 5 is a diagram provided to describe a wavefront optimization process according to an embodiment of the present invention.

FIG. 6 is a diagram provided to describe an operation of recording an optimized wavefront on photorefractive materials in accordance with an embodiment of the present invention.

FIG. 7 is a diagram provided to describe an operation of reconstructing a wavefront recorded on the photorefractive materials in accordance with an embodiment of the present invention.

FIG. 8 is a block diagram showing the general configuration of an optical element according to an embodiment of the present invention.

FIG. 9 is a diagram showing a light focus using an SOE according to an embodiment of the present invention.

FIG. 10 is a diagram showing a two-dimensional image formed using the SOE according to an embodiment of the present invention.

FIG. 11 is a diagram provided to describe an operation of generating light having various polarization components using complex media in accordance with an embodiment of the present invention.

### DETAILED DESCRIPTION

Hereinafter, embodiments of the present invention are described in detail with reference to the accompanying drawings.

The present embodiments relate to a technology for controlling the optical properties of light by omitting the optical design of an optical element and a medium-related fabrication process through wavefront optimization and the recording and reconstruction of a wavefront. In particular, the present embodiments relate to a technology for controlling the optical properties of light transmitted and reflected by complex media by making incident light having good coherency, that is, coherent light, on the complex media (highly disordered media) and controlling the wavefront of the light incident on the complex media. Specifically, the present embodiments relate to a technology for controlling the optical properties of light transmitted or reflected by complex media, such as the amplitude, phase, wavelength, vibration number and near-field information of the light, so that the light has a desired optical field by controlling the phase, amplitude, etc. of the light incident on the complex media that generates multiple light scattering.

In the present embodiments, the optical properties of light may include the amplitude, phase, wavelength, polarization, etc. of the light. Furthermore, an optical mode indicates an interaction between light and a medium. For example, the optical mode may indicate the bases of different optical fields of transmitted or reflected light when the light incident on the complex media is transmitted or reflected by the complex media. Furthermore, the number of optical modes in the complex media may be a number obtained by dividing the area of the complex media by Abbe's diffraction limit.

In the present embodiments, an optical element may indicate an optical device. Furthermore, in the present embodiments, a controlled wavefront recorded on photorefractive materials may indicate an optimized wavefront found out through wavefront optimization.

In the present embodiments, an example in which an interference pattern formed through interference between a reference beam and a signal beam having the wavefront of a controlled signal beam, that is, an optimal wavefront found out through wavefront optimization, is recorded on photorefractive materials is described, but this corresponds to an embodiment. In addition to the photorefractive materials, a holographic phase film, etc. may be used. That is, the interference pattern may be recorded on the holographic phase film.

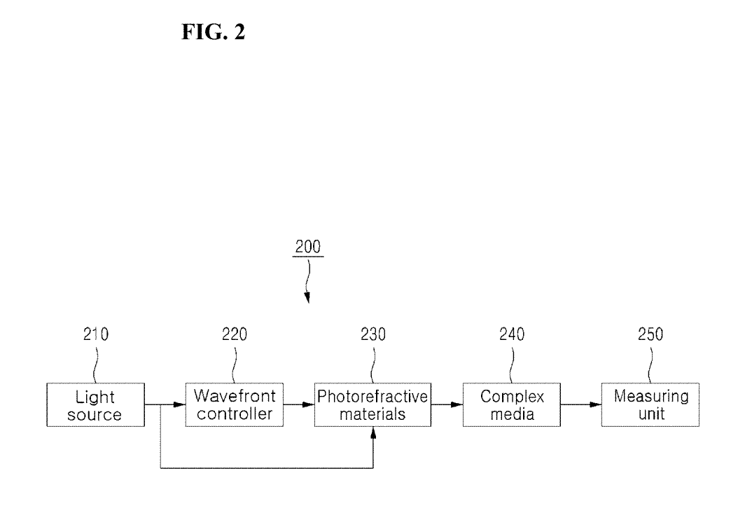

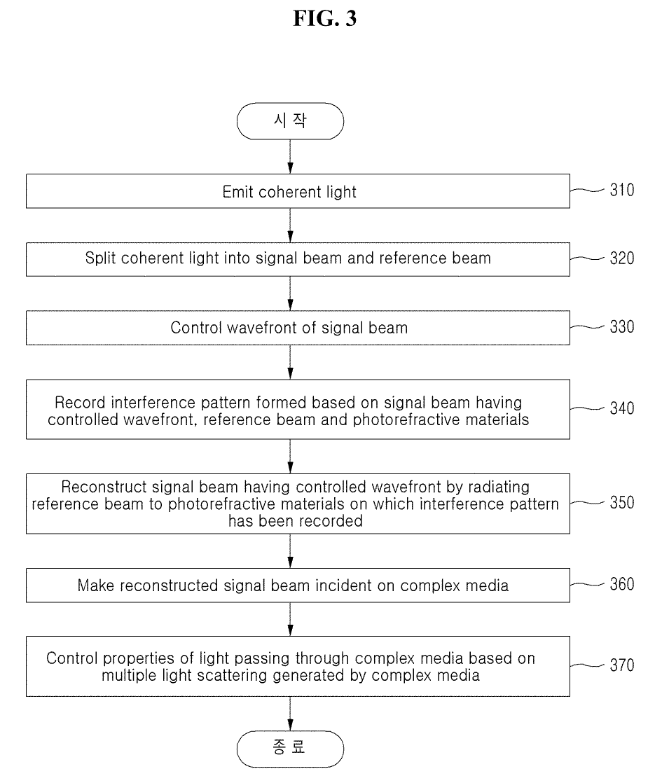

FIG. 2 is a block diagram showing the internal configuration of an optical element using multiple light scattering in accordance with an embodiment of the present invention. FIG. 3 is a flowchart showing a method of controlling the optical properties of light using multiple light scattering in the optical element in accordance with an embodiment of the present invention.

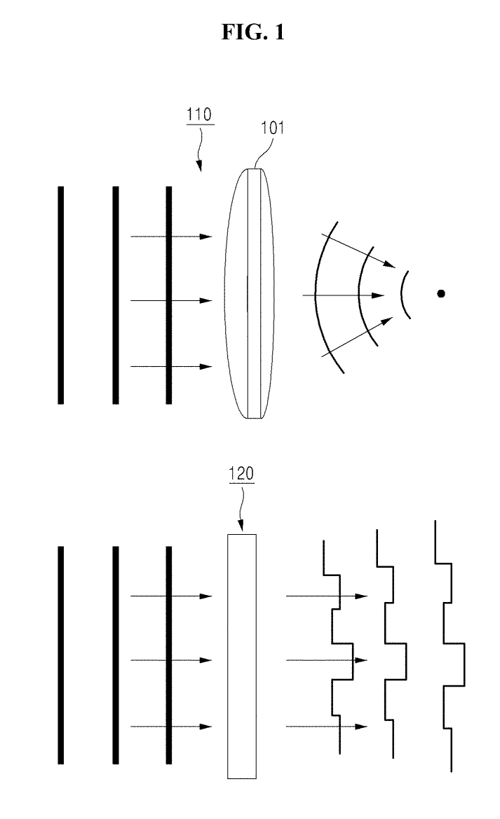

In FIG. 2, the optical element 200 may include a light source 210, a wavefront controller 220, photorefractive materials 230, complex media 240 and a measuring unit 250. Furthermore, steps 310 to 370 of FIG. 3 may be performed by the elements of the optical element 200 of FIG. 1, for example, the light source 210, the wavefront controller 220, the photorefractive materials 230, the complex media 240 and the measuring unit 250.

At step 310, the light source 210 emits coherent light having good coherency using multiple light scattering in order to control the optical properties of the light.

For example, a laser for radiating coherent light emitted by the light source 210 and having coherency of a predefined reference value or more may be used as the light source 210.

At step 320, the coherent light emitted by the light source 210 may be split into a signal light and a reference light.

For example, a beam splitter located behind the light source 210 may receive the coherent light emitted by the light source 210 and split the received coherent light into a signal beam and a reference beam. The signal beam may be used for wavefront optimization, and the reference beam may be used to form an interference pattern. For example, the signal beam may be transmitted to the wavefront controller 220 for wavefront optimization, and the reference beam may be blocked from being incident on the photorefractive materials 230 for a specific time (e.g., the time taken for wavefront optimization to be completed).

At step 330, the wavefront controller 220 may receive the signal beam split from the coherent light and control the wavefront of the signal beam.

For example, the wavefront controller 220 may control the wavefront of the signal beam so that the signal beam has a wavefront indicative of a desired optical field by changing the phase, amplitude, etc. of the signal beam. That is, the wavefront controller 220 may repeatedly change the phase, amplitude, etc. of the signal beam for wavefront optimization. The measuring unit 250 may check whether the wavefront of the measured signal beam indicates a predefined desired optical field by measuring the changed phase, amplitude, polarization, wavelength, etc. of the signal beam. An optimal wavefront can be found out through wavefront optimization for repeatedly changing and measuring the phase, amplitude, etc. of the signal beam as described above.

Furthermore, a spatial light modulator (SLM), a dynamic mirror device or a deformable mirror device may be used as the wavefront controller 220. Furthermore, at least two or more of the SLM, the dynamic mirror device and the deformable mirror device may be combined and used for control of the wavefront. For example, the wavefront controller 220 may be implemented in a combined form, such as the SLM and the dynamic mirror device or the SLM and the deformed mirror device.

At step 340, an interference pattern may be formed based on the signal beam having the wavefront controlled by the wavefront controller 220, the reference beam (i.e., the reference beam split from the coherent light), and the photorefractive materials. The formed interference pattern may be recorded on the photorefractive materials.

That is, after the optimal wavefront of the signal beam is found out through the wavefront optimization, the signal beam having the optimal wavefront may illuminate the photorefractive materials 230. In this case, the signal beam having the optimal wavefront (i.e., the signal beam having the controlled wavefront) and the reference beam split by the beam splitter may be incident on the photorefractive materials 230 almost at the same time. In this case, the reference beam may be incident on the photorefractive materials 230 through a single mode optical fiber (SMF), the incidence of the reference beam on the photorefractive materials 230 may be blocked until the optimal wavefront is found out. In this case, the reference beam and the signal beam having the optimal wavefront may be incident on the photorefractive materials 230 with strong intensity of predetermined reference intensity or more.

In this case, after the coherent light is split into the reference beam and the signal beam, there may be a path difference because light paths experienced by the split reference beam and signal beam are different. If the path difference corresponds to a coherence length or less of predefined coherent light (e.g., laser light), the reference beam and signal beam incident on the photorefractive materials 230 at the same time may generate interference each other. Accordingly, the signal beam and reference beam incident on the photorefractive materials 230 form an interference pattern having spatially various intensities of light. The formed interference pattern may be recorded on the photorefractive materials 230 as refractive index information.

For example, the photorefractive materials 230 may include a photopolymer, that is, photopolymer materials, and photorefractive crystals. In other words, the interference pattern formed based on the signal beam having the optimal wavefront may be recorded on the photopolymer. Accordingly, in order to generate a desired optical field by semi-permanently using the interference pattern recorded on the photopolymer, the interference pattern recorded on the photopolymer may be fixed by performing a UV cure on the photopolymer.

At step 350, the photorefractive materials 230 may reconstruct the signal beam having the controlled wavefront by radiating the reference beam to the photorefractive materials 230 on which the interference pattern has been recorded.

For example, when the optimal wavefront is found out and the interference pattern is recorded on the photorefractive materials 230, the signal beam split from the coherent light can be blocked from being incident on the photorefractive materials 230 through the wavefront controller 220. As described above, the incidence of the signal beam may be blocked, and the coherent light may illuminate the photorefractive materials 230 after the split reference beam passes through the SMF. Accordingly, the reference beam illuminated to the photorefractive materials 230 may be diffracted or scattered by the interference pattern recorded on the photorefractive materials 230. The signal beam whose wavefront has been optimized due to the diffraction and scattering may be reconstructed in the photorefractive materials 230.

At step 360, the reconstructed signal beam may be incident on the complex media 240. That is, the signal beam having the controlled wavefront (i.e., the signal beam having the optimal wavefront) may be reconstructed in the photorefractive materials 230 and may be incident on the complex media 240.

At step 370, when the signal beam having the controlled wavefront is incident on the complex media 240, the properties of light transmitted or reflected by the complex media 240 may be controlled so that the light has a desired optical field based on multiple light scattering generated by the complex media 240.

The complex media 240 may mix the amplitude, phase, wavelength, polarization, etc. of light incident on the media and the amplitude, phase, wavelength, polarization, etc. of light transmitted and reflected by the media. Accordingly, if at least one of the phase, amplitude, wavelength and polarization of light incident on the complex media 240 is changed (i.e., controlled) through the wavefront controller 220, all of the amplitude, phase, wavelength and polarization of light output through the complex media 240 may be controlled.

For example, if the phase of light incident on the complex media 240 is controlled, light incident with the controlled phase may be output through the complex media 240. The phase, amplitude, wavelength and polarization of the light output through the complex media 240 may be controlled so that the light has a desired optical field. For example, if the phase of light incident on the complex media 240 is controlled, the phase of light output through the complex media 240 may be controlled, and a light focus may be formed at a predefined desired location (i.e., a target point) by controlling phase information of the output beam. In addition, pieces of light having different wavelength components have different light responses although they pass through the complex media 240. Accordingly, the light may be controlled so that a light focus is formed at a desired location for each wavelength using such a light response. Furthermore, light having various polarization components may be generated using the complex media 240.

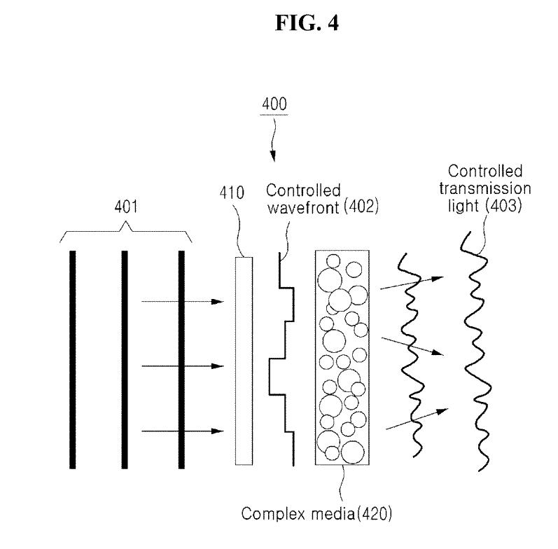

FIG. 4 is a diagram provided to describe an operation of controlling the properties of light using the photorefractive materials on which a controlled wavefront has been recorded and the complex media in accordance with an embodiment of the present invention.

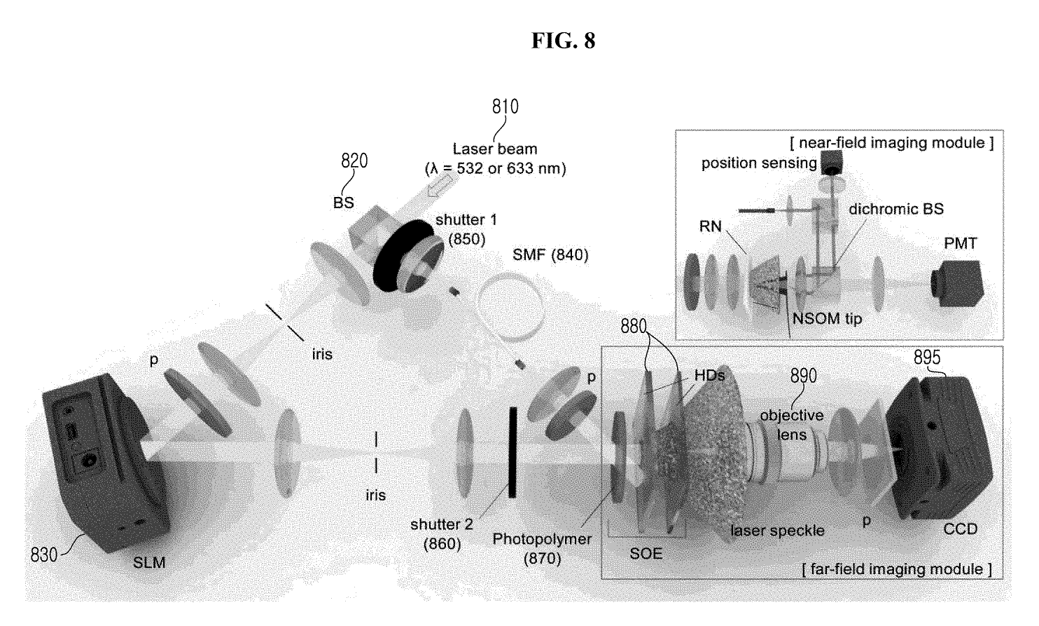

In FIG. 4, a scattering optical element (SOE) 400 may include photorefractive materials 410 and complex media 420, and may be implemented in a stand-alone form. The SOE 400 includes the photorefractive materials 410 (e.g., a photopolymer) and the complex media 420. To implement the SOE 400 in a stand-alone form may mean that after the SOE is fabricated through wavefront optimization, it may be separated from the optical element of FIG. 8 and used. That is, the SOE 400 may independently operate without the SLM and other optical systems (e.g., a shutter, a beam splitter and an iris) after an optimal wavefront is recorded on the photorefractive materials 410, such as a photopolymer, through wavefront optimization.

Furthermore, the SOE 400 is part of the optical element 200 of FIG. 1. When light incident on the complex media 420 is output through the complex media 420, the SOE may function to substantially control the properties of the output light.

For example, a reference beam of a polarization component may illuminate the photorefractive materials 410 on which a controlled wavefront has been recorded (i.e., on which an interference pattern formed based on a signal beam having an optimal wavefront has been recorded). Accordingly, the reference beam 401 of a polarization component is diffracted or scattered by the interference pattern recorded on the photorefractive materials 410, so a signal beam optimized in the photorefractive materials 410 (i.e., a signal beam 402 having an optimal wavefront) may be reconstructed. Accordingly, the optimized signal beam 402 is incident on the complex media 420, and the wavefront of the signal beam 402 may be subjected to multiple light scattering by the complex media 420. In this case, as the signal beam 402 whose wavefront has been optimized is incident on the complex media 420, controlled multiple light scattering may be generated by the complex media 420. Accordingly, the measuring unit 250 may photograph light output through the complex media 420, that is, a pattern (e.g., a speckle pattern) related to multiple-scattered light. Furthermore, it may be seen that the optical properties of the output light has been controlled so that it has an optical field of a predefined desired form by measuring optical properties using the measuring unit 250 based on the photographed image. For example, the optical properties of the light (i.e., multiple-scattered light) output through the complex media 420, such as a polarization state, a frequency spectrum, a high spatial frequency and near-field information, may be controlled in a desired form.

As described above, light emitted by the light source (e.g., a laser light source) having good coherency may be scattered several times (i.e., multiple light scattering) by the complex media 420 in various directions. The multiple-scattered light may have a spatio-temporal intensity distribution of a very complex form due to constructive interference or destructive interference. Such a spatio-temporal intensity distribution is called a speckle or a speckle pattern. By photographing the speckle pattern using the measuring unit 250 including a photographing device, such as a CCD, and analyzing the photographed image, whether the properties of the light transmitted or reflected by the complex media 420, that is, the properties of the multiple-scattered light, have been controlled so that they have an optical field of a desired form. For example, if specific light, that is, light not having an optimized wavefront, is incident on the complex media 420, the incident light undergoes multiple light scattering by the complex media 420. The multiple-scattered light may form a randomly distributed speckle pattern, that is, a speckle pattern of a complex form. In contrast, when light having an optimized wavefront is incident on the complex media 420, the incident beam generates controlled multiple light scattering by the complex media 420. It may be seen that a speckle pattern formed by the controlled multiple-scattered light has a desired optical field by photographing the speckle pattern.

As described above, the form of a speckle form looks very complicated and disordered, but the form of a speckle may not be changed if the optical structure of a material that generates scattering and the properties of incident light are not changed. The reason for this is that a multiple light scattering phenomenon is a deterministic phenomenon expressed as a wave form. Accordingly, the amplitude, wavelength, polarization, vibration number information, etc. of light that has experienced multiple light scattering by the complex media 420 and passed through the complex media 420 can be controlled by controlling the properties (e.g., a phase and amplitude) of light incident on the complex media 420 using the SLM and making it incident on the complex media 420.

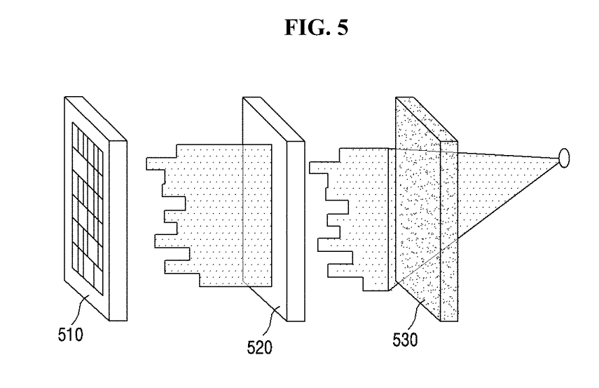

FIG. 5 is a diagram provided to describe a wavefront optimization process according to an embodiment of the present invention.

In FIG. 5, an example in which the SLM is used as the wavefront controller 220 is described, but a dynamic mirror device or a deformed mirror device may be used as the wavefront controller in addition to the SLM. In the wavefront optimization process, a reference beam may be blocked, and only a signal beam may be used.

When the light source emits coherent light having good coherency, the coherent light or a signal beam from the beam splitter may be incident on the SLM 510. The SLM 510 may change the phase or amplitude of the incident signal beam in order to spatially them. In this case, an iterative optimization algorithm using the SLM 510 may be used for wavefront optimization. The SLM 510 may repeatedly change the phase or amplitude of the incident signal beam until it finds out an optimal wavefront for the wavefront optimization. For example, in accordance with the iterative optimization algorithm suggested in Non-Patent Document [1], an operation of changing, by the SLM 510, the phase or amplitude of the incident signal beam, making the changed signal beam incident on the complex media 530 through the photorefractive materials 520, and measuring, by the measuring unit 250, information of light (e.g., the signal intensity of light output through the complex media 530) subjected to multiple light scattering by the complex media 530 may be repeatedly performed until an optimal wavefront is found out. When the optimal wavefront is found out, the wavefront optimization may be completed. As described above, the SLM 510 may control the light output through the complex media 530 so that the light forms constructive interference or destructive interference at a predefined target point by changing the phase or amplitude of the signal beam.

In addition, wavefront optimization may be performed using a method of measuring the transmission matrix of the complex media 530 or a time-reversal approach based on optical phase conjugation.

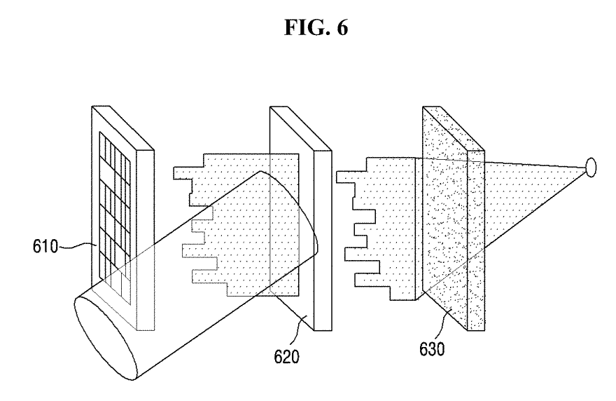

FIG. 6 is a diagram provided to describe an operation of recording an optimized wavefront on the photorefractive materials in accordance with an embodiment of the present invention.

Referring to FIG. 6, after the SLM 610 finds out an optimal wavefront by changing the phase or amplitude of an incident signal beam, the found optimal wavefront may be recorded on the photorefractive materials 620, such as a photopolymer.

For example, when wavefront optimization is completed, a signal beam having an optimal wavefront and a reference beam passing through the SMF illuminates the photorefractive materials 620 at the same time. In this case, if a path difference between transmission light (i.e., a signal beam) and a reference beam met again in the photorefractive materials 620 after passing through the beam splitter from the emission of coherent light by the light source 210 is within the coherence length of a predefined laser light source, the signal beam and the reference beam may interfere with each other in the photorefractive materials 620. At this time, the optical refractive index of a component forming the photorefractive materials 620 may be changed depending on intensity of light incident on the photorefractive materials 620. That is, in an interference pattern formed in the photorefractive materials 620 by the signal beam and the reference beam, an area in which intensity of light is spatially strong may more rise than a portion in which intensity of the refractive index of the photorefractive materials 620 is low, and a portion in which the refractive index of the light whose intensity is 0 may not be changed. Accordingly, the interference pattern formed as the reference beam and the signal beam having an optimal wavefront are illuminated at the same time may be recorded on the photorefractive materials 620 as refractive index information. Furthermore, after the interference pattern is recorded, a UV cure for radiating ultraviolet rays (UV) to the photorefractive materials 620 may be performed. The refractive index of the photorefractive materials 620 may be fixed through the UV cure so that the refractive index is no longer changed by subsequently incident light. That is, a refractive index corresponding to the interference pattern by the signal beam having the optimal wavefront can be maintained and fixed in the photorefractive materials 620.

A holographic phase film or photorefractive crystals may be used as the photorefractive materials 620 in addition to the photopolymer.

As described above with reference to FIG. 6, when an interference pattern corresponding to a desired wavefront (i.e., optimal wavefront) is recorded on the photorefractive materials 620, the wavefront controller 220, such as the SLM, is no longer used, and the SOE including the photorefractive materials 620 and the complex media 630 may be independently used. That is, a signal beam is blocked and no longer used, and a desired optical field can be obtained by radiating a reference beam to the SOE.

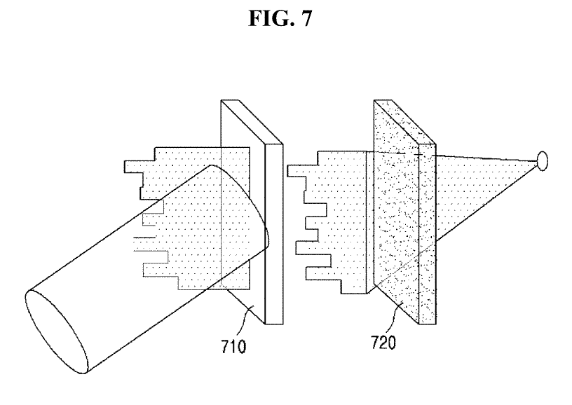

FIG. 7 is a diagram provided to describe an operation of reconstructing a wavefront recorded on the photorefractive materials in accordance with an embodiment of the present invention.

When an interference pattern corresponding to a desired wavefront (i.e., an optimal wavefront) is recorded on the photorefractive materials 710, a signal beam may be blocked. For example, a shutter for blocking the signal beam may be disposed between the wavefront controller 220 and the photorefractive materials 710, 230. After the incidence of the signal beam on the photorefractive materials 710 is blocked as described above, a reference beam may illuminate the photorefractive materials 710. Accordingly, the reference beam is diffracted or scattered by the interference pattern recorded on the photorefractive materials 710, thereby being capable of reconstructing a signal beam having an optimized wavefront.

FIG. 8 is a block diagram showing the general configuration of an optical element according to an embodiment of the present invention.

Referring to FIG. 8, the optical element 800 may include a light source 810, a beam splitter 820, a wavefront controller 830, an SMF 840, a shutter 1 850, a shutter 2 860, photorefractive materials 870, complex media 880, an object lens 890 and a CCD 895. In FIG. 8, the photorefractive materials 870 and the complex media 880 correspond to the SOE, and may be implemented in a stand-alone form. The object lens 890 and the CCD 895 may correspond to the measuring unit 250 of FIG. 2. Furthermore, a single complex medium 880 or a plurality of complex media 880 may be configured depending on the type of medium. For example, in FIG. 8, a plurality of holographic diffusers (HDs) has been used as the complex media 880, but this corresponds to an embodiment. TiO2 nanoparticles may be used as the complex media 880.

In FIG. 8, the SLM has been used as the wavefront controller 830, and the operations of the light source 810, the wavefront controller 830, the photorefractive materials 870, the complex media 880 and the CCD 895 (i.e., the measuring unit) have been already described with reference to FIG. 2 and a redundant description thereof is omitted.

Referring to FIG. 8, the beam splitter 820 is disposed between the light source 810 and the wavefront controller 830, and may split coherent light emitted by the light source 810 into a signal beam and a reference beam. Furthermore, the signal beam is incident from the beam splitter 820 to the wavefront controller 830. The phase, amplitude, etc. of the signal beam are changed through the wavefront controller 830, and thus the signal beam may be used for wavefront optimization. In this case, while the wavefront optimization is performed, the beam splitter 820 may include the shutter 1 850 so that the split reference beam is not incident on the photorefractive materials 870, that is, in order to block the split reference beam. As described above, the shutter 1 850 included in the beam splitter 820 can block the reference beam split by the beam splitter 820 so that the reference beam does not illuminate the SMF 840 and the photorefractive materials 870 until the wavefront optimization is completed.

When the wavefront optimization is completed, the shutter 1 850 is open, so the reference beam may be transferred to the SMF 840. Accordingly, the reference beam passing through the SMF 840 illuminates the photorefractive materials 870 simultaneously with a signal beam having an optimal wavefront, thereby being capable of forming an interference pattern. After the interference pattern is recorded on the photorefractive materials 870, the signal beam may be blocked. The shutter 2 860 disposed between the wavefront controller 830 and the photorefractive materials 870 can block the signal beam from being incident on the photorefractive materials 870. In addition, in the process of recording the interference pattern, the shutter 2 860 may be used to make the signal beam having the optimal wavefront incident on the photorefractive materials 870 simultaneously with the reference beam.

The object lens 890 may collect light multiple-scattered by the complex media 880. Accordingly, the CCD 895 may measure intensity of the light by photographing the collected multiple-scattered light.

As described above, by controlling the wavefront of light incident on the complex media, measuring light multiple-scattered by the complex media, and recording and reconstructing the light on the photopolymer, the properties of the light can be controlled so that it has a desired optical field without the optical design and a process of fabricating a medium in a specific form (e.g., an etching process of cutting a lens or a process using a lithography technology). For example, the phase of light output through the complex media 880 can be controlled when the wavefront controller 830 controls the phase of an incident signal beam. If the phase of light output through the complex media 880 is controlled, a light focus can be formed at a desired location. Furthermore, a light focus can be formed at a desired location for each wavelength because pieces of light having different wavelength components have different responses although they pass through the same complex media 880. Light having various polarization components can be produced using the complex media 880.

Furthermore, near-field information of light output through the complex media 880 may be controlled. The near-field information may be controlled because intensity of the light is controlled in an area smaller than Abbe's diffraction limit. A basis principle that the near-field information is controlled is similar to control of other properties (e.g., amplitude, a phase and polarization) of light using the SOE. The type of complex media and an optical system necessary for wavefront optimization may be different. For example, as shown in FIG. 8, near-field components of light scattered by the complex media may be measured using near-field scanning microscopy (NSOM), and optimization may be performed based on the measured near-field components. In this case, a medium capable of scattering light in a near-field form when a far-field is incident may be used as the complex media if the NSOM is used. For example, since light recorded and reconstructed in the photopolymer is a far-field, random nanoparticles may be used as the complex media. Accordingly, the far-field whose wavefront has been controlled by the photopolymer is incident on the complex media, and the near-field component (i.e., near-field information) of the light scattered by the complex media may have a desired form.

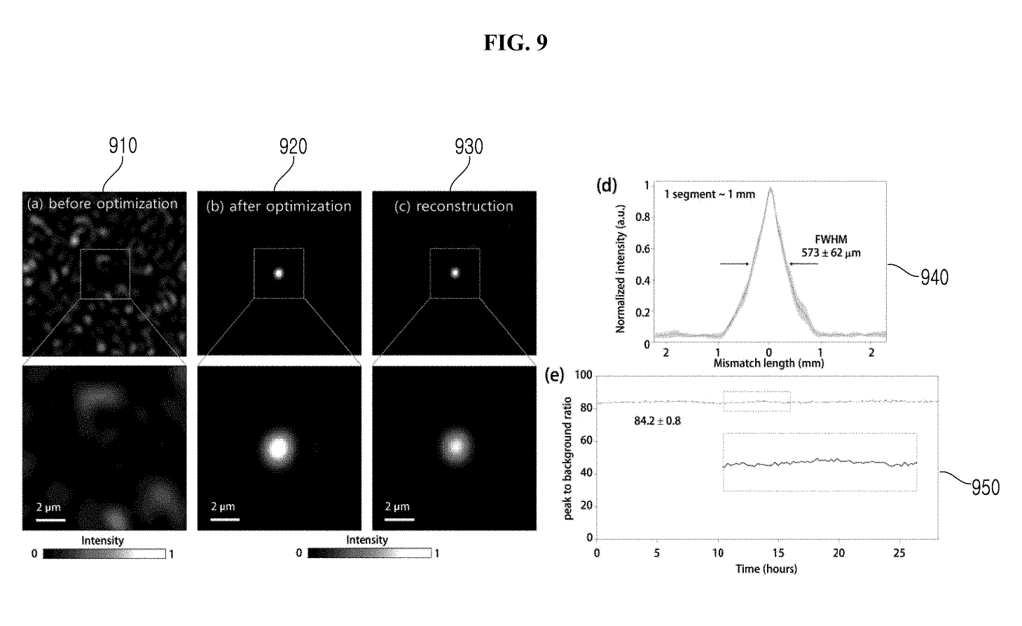

FIG. 9 is a diagram showing a light focus using the SOE according to an embodiment of the present invention.

In FIG. 9, 910 may show intensity of an optical field shown by light that has been output through the complex media 880 prior to wavefront optimization. 920 may show intensity of an optical field (i.e., intensity of light) shown by light output through the complex media 880 after wavefront optimization. 930 may show an optimized optical field (i.e., a signal beam having an optimal wavefront) reconstructed using the SOE. In this case, the FWHM of a focus may be measured as ˜1.5 μm determined by the effective numerical aperture (NA) of the SOE.

That is, it may be seen that prior to the wavefront optimization, the focus 910 is not clear because a speckle pattern of a complex form is formed behind the complex media 880 as in 910, but after the wavefront optimization, the focus has become clear as in 920. Furthermore, it may be seen that the focus of the light reconstructed in the complex media 880 also become clear as in 930.

940 is a graph showing the relation between a mismatched length of a wavefront and intensity of a focus, and may indicate intensity of the focus generated while a photopolymer film is laterally converted. From the graph 940, it may be seen that the focus fully disappears if the mismatched length has the same size as a segment, that is, if the correlation between an optimized wavefront and a wavefront incident on the complex media is 0. That is, it may be seen that intensity of the focus is reduced as the mismatch of an incident wavefront increases. In other words, the mismatch shows a mismatch between the wavefront of light incident on the photopolymer and an optimized wavefront.

940 may show how intensity of a light focus is changed depending on the size of a mismatch between a wavefront optimized to form the light focus and a wavefront actually recorded and reproduced in the photopolymer.

Furthermore, 950 shows the time-persistence of a focus. From the graph 950, it may be seen that the SOE is very stable over a long time.

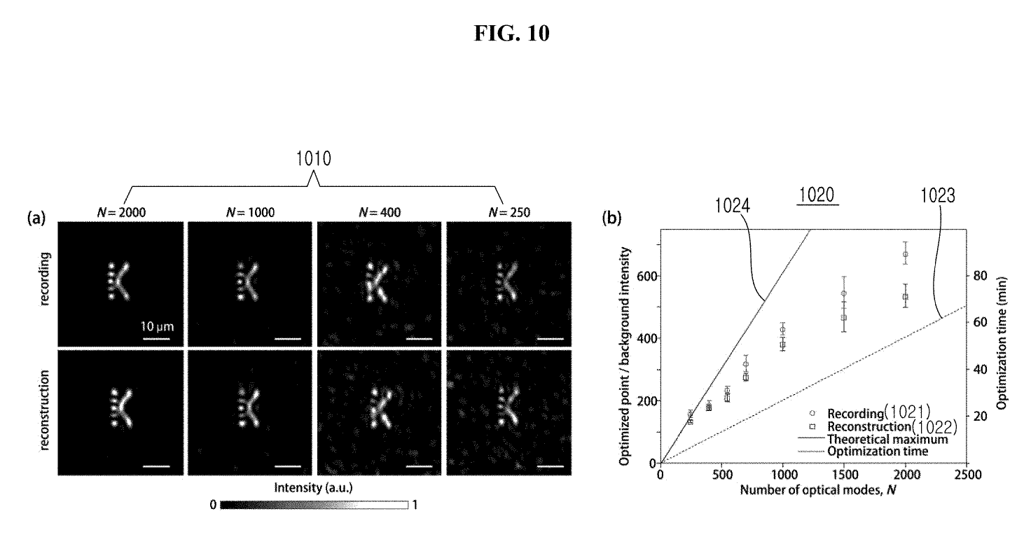

FIG. 10 is a diagram showing a two-dimensional image formed using the SOE according to an embodiment of the present invention.

FIG. 10 shows an image corresponding to a micrometer-sized letter “K.” In order to find out an optimal wavefront corresponding to the letter “K”, a method of measuring the transmission matrix of the complex media may be used. Images 1010 show images of the letter K according to the number N of optical modes. It may be seen that the image of the letter K becomes clearer as the number N of optical modes increases. For example, it may be seen that the letter K becomes gradually clearer in order of N=400, 1000, 2000 compared to N=250. The wavefront optimization time is reduced as the number of optical modes is decreased, but the quality of a reconstructed image may also be decreased because the peak-background ratio is decreased. Accordingly, it may be seen that as the number of optical modes increases, the wavefront optimization time is increased, but the quality of a reconstructed image (an image including the letter K) becomes better.

In a graph 1020, 1021 may show intensity of a signal optimized prior to recording, and 1022 may show intensity of a signal reconstructed through the SOE. 1023 shows the time taken for wavefront optimization and may be variable depending on the performance of the SLM and the optical system. Furthermore, 1024 may show the background-to-noise versus a peak value of light or the signal to noise (SNR) versus a peak value of light which may be theoretically obtained depending on the number of optical modes used.

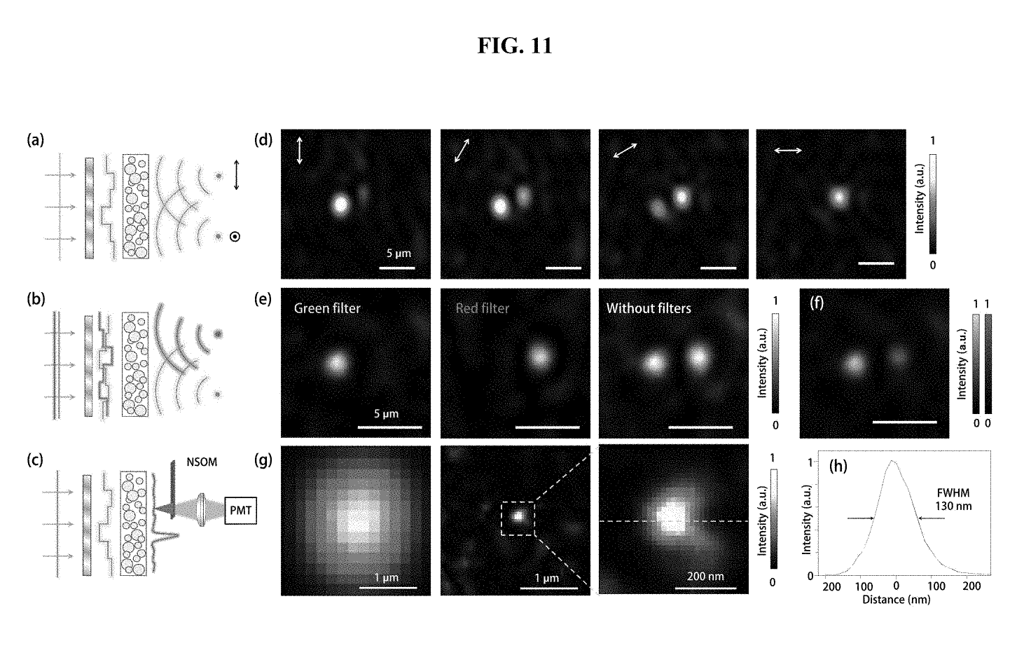

FIG. 11 is a diagram provided to describe an operation of generating light having various polarization components using complex media in accordance with an embodiment of the present invention.

In FIG. 11, in order to generate light having various polarization components, random nanoparticles (RN) instead of the HD may be used as the complex media of FIG. 8, and a photomultiplier tube (PMT) may be used instead of the object lens and the CCD.

In FIG. 11, (a) is the concept diagram of control of polarization, and may show that a controlled wavefront is reconstructed after a plane wave is incident on the photopolymer, that is, the photorefractive materials. In this case, the generated controlled wavefront may form two focuses having polarization components vertical to each other after experiencing the complex media.

In FIG. 11, (b) shows the concept diagram of control of a wavelength. After two beams having different wavelength components are incident on the photopolymer, a controlled wavefront may be reconstructed. In this case, the controlled wavefront may form a light focus in a different space for each wavelength after experiencing the complex media.

In FIG. 11, (c) shows the concept diagram of control of the near-field. A controlled wavefront may be incident on the complex media by the photopolymer. In this case, the near-field component of light scattered by the complex media may be measured using a near-field scanning microscopy (NSOM) device. In this case, the NSOM may include a probe tip functioning to convert the near-field on a surface of a sample into the far-field and a photomultiplier tube (PMT), that is, a device for measuring light with very high sensitivity of a predefined specific value or more.

In FIG. 11, (d) may show the results of the experiment of the polarization control described in FIG. 11(a). For example, intensity of two light focuses formed using the CCD may be measured. In this case, the analyzer may be disposed ahead of the CCD, and the CCD may measure intensity of the light according to the arrow orientation of the analyzer. It may be seen that the two focuses having different polarizations are formed through such intensity measurement.

In FIG. 11, (e) may show the results of the experiment of the wavelength control described in FIG. 11(b). Intensity of two light focuses formed may be measured using the CCD. In this case, a green or red spectral filter capable of transmitting only a specific wavelength may be disposed ahead of the CCD. It may be seen that the two focuses have different wavelength components by measuring the wavelength passing through the green or red spectral filter using the CCD. Accordingly, it may be seen that the two focuses are green and red focuses as shown in FIG. 11(f).

In FIG. 11(g), the leftmost drawing shows that a light focus having the far-field has been formed. The middle and rightmost drawings are the results of the experiment of the near-field control described in FIG. 11(c), and may show light focuses of a small size generated using the near-field.

FIG. 11(h) shows the results of the measurement of intensity of a formed near-field light focus along the cross section shown in the rightmost drawing of FIG. 11(g). From FIG. 11(h), it may be seen that the full width half maximum (FWHM) of the light focus is about 130 nm and is smaller than a light focus which may be generated using the far-field.

In accordance with the present invention, the optical properties of light transmitted and reflected by the complex media can be controlled by controlling the wavefront of the light incident on the complex media in which multiple light scattering is generated although the optical design and fabrication process are omitted.

In accordance with the present invention, the optical element can be implemented at low costs (i.e., economic costs) because the optical element is configured using the complex media and cheap optical polymers. Furthermore, near-field information whose control is difficult in a conventional technology can also be controlled in addition to the amplitude, wavelength, polarization and phase of light that passes through the complex media.

In accordance with the present invention, a controlled wavefront, specifically, an interference pattern generated by light having the controlled wavefront can be recorded on the photorefractive materials, and the light having the controlled wavefront can be semi-permanently reconstructed based on the recorded interference pattern.

As described above, although the embodiments have been described in connection with the limited embodiments and the drawings, a person having ordinary skill in the art may modify and change the embodiments in various ways from the description. For example, proper results may be achieved although the aforementioned descriptions are performed in order different from that of the described method and/or the aforementioned elements, such as the system, configuration, device and circuit, are coupled or combined in a form different from that of the described method or replaced or substituted with other elements or equivalents.

Accordingly, other implementations, other embodiments, and the equivalents of the claims belong to the scope of the claims.

The embodiments of the invention in which an exclusive property or privilege is claimed are defined as follows:

1. An optical control method using multiple light scattering, comprising steps of:
splitting coherent light into a signal beam and a reference beam;
controlling a wavefront of the signal beam;
forming an interference pattern by making the signal beam having the controlled wavefront and the reference beam incident on photorefractive materials;
recording the interference pattern on the photorefractive materials;
reconstructing the signal beam having the controlled wavefront by the interference pattern by radiating the reference beam to the photorefractive materials on which the interference pattern has been recorded again; and
controlling properties of light passing through complex media based on multiple light scattering generated by the complex media as the reconstructed signal beam is incident on the complex media.

2. The method of claim 1, wherein the step of controlling the wavefront of the signal beam comprises steps of:
controlling at least one of a phase and amplitude of the signal beam incident on the photorefractive materials using a wavefront controller;
making the signal beam at least one of whose phase and amplitude has been controlled incident on the photorefractive materials;
making a signal beam passing through the photorefractive materials incident on the complex media; and
performing wavefront optimization by measuring information of light output through the complex media.

3. The method of claim 2, wherein in the step of forming the interference pattern, after the signal beam whose wavefront has been optimized and the reference beam illuminate the photorefractive materials with strong intensity of predetermined reference intensity or more and pass through a beam splitter, if a path difference between the signal beam and the reference beam met again in the photorefractive materials corresponds to a predefined coherence length or less, the signal beam and the reference beam interfere with each other in the photorefractive materials to form the interference pattern.

4. The method of claim 2, wherein while the optimization of the wavefront of the signal beam is performed, the reference beam is blocked from being incident on the photorefractive materials.

5. The method of claim 1, wherein the step of reconstructing the signal beam having the controlled wavefront comprises steps of:
blocking the signal beam from being incident on the photorefractive materials; and
reconstructing the signal beam having the controlled wavefront as the reference beam which has illuminated the photorefractive materials on which the interference pattern has been recorded again is diffracted or scattered by the interference pattern.

6. The method of claim 1, wherein the interference pattern is formed in the photorefractive materials as the reference beam is incident on the photorefractive materials after passing through a single mode fiber (SMF).

7. The method of claim 1, wherein the step of controlling the properties of the light passing through the complex media comprises controlling amplitude, phase, wavelength and polarization of the light passing through the complex media by controlling at least one of a phase and amplitude of the light incident on the complex media.

8. The method of claim 1, wherein the step of recording the interference pattern on the photorefractive materials comprises performing a UV cure by radiating ultraviolet rays to the photorefractive materials on which the interference pattern has been recorded.

9. An optical element using multiple light scattering, comprising:
a wavefront controller configured to control a wavefront of a signal beam split from coherent light;
photorefractive materials on which the signal beam having the controlled wavefront and a reference beam split from the coherent light are incident to form an interference pattern and on which the formed interference pattern is recorded;
complex media on which the signal beam having the controlled wavefront reconstructed as the reference beam illuminates the photorefractive materials on which the interference pattern has been recorded again is incident; and
a measuring unit configured to control and measure properties of light passing through the complex media based on multiple light scattering generated by the complex media.

10. The optical element of claim 9, wherein:
the wavefront controller changes at least one of a phase and amplitude of the signal beam incident on the photorefractive materials and makes the signal beam at least one of whose phase and amplitude has been changed incident on the photorefractive materials, and
the measuring unit performs wavefront optimization by measuring information of light output after a signal beam passing through the photorefractive materials passes through the complex media.

11. The optical element of claim 10, wherein the interference pattern is formed as the signal beam and the reference beam interfere with each other in the photorefractive materials if a path difference between the signal beam and the reference beam met again in the photorefractive materials corresponds to a predefined coherence length or less after the signal beam whose wavefront has been optimized and the reference beam illuminate the photorefractive materials with strong intensity of predetermined reference intensity or more and pass through a beam splitter.

12. The optical element of claim 9, further comprising:
a light source configured to emit the coherent light; and
a beam splitter configured to split the coherent light into the signal beam and the reference beam.

13. The optical element of claim 12, wherein the beam splitter blocks the reference beam from being incident on the photorefractive materials while optimization is performed on the wavefront of the signal beam.

14. The optical element of claim 9, further comprising a shutter configured to block the signal beam from being incident on the photorefractive materials after the interference pattern is recorded on the photorefractive materials.

15. The optical element of claim 14, wherein:
the photorefractive materials reconstruct the signal beam having the controlled wavefront as the reference beam illuminated from the beam splitter is diffracted or scattered by the interference pattern, and
the shutter is disposed between the wavefront controller and the photorefractive materials.

16. The optical element of claim 9, further comprising a single mode fiber (SMF) configured to transmit the reference beam split by a beam splitter,
wherein the reference beam passing through the SMF is incident on the photorefractive materials.

17. The optical element of claim 9, wherein amplitude, phase, wavelength and polarization of light output through the complex media is controlled as at least one of a phase and amplitude of the light incident on the complex media is controlled through the wavefront controller.

18. The optical element of claim 9, wherein a UV cure for radiating ultraviolet rays to the photorefractive materials on which the interference pattern has been recorded is performed.

19. The optical element of claim 9, wherein:
as the signal beam having an optimized wavefront passes through the complex media, the transmitted beam indicates a predefined desired optical field, and
as a signal beam having a not-optimized wavefront passes through the complex media, the transmitted beam indicates a speckle pattern having a spatio-temporally random intensity distribution.

20. A scattering optical element, comprising:
photorefractive materials on which an interference pattern formed based on light having a wavefront controlled through wavefront optimization is recorded; and
complex media on which light radiated to the photorefractive materials and the light having the controlled wavefront generated based on the interference pattern are incident and configured to transmit or reflect the incident light,
wherein the light incident on the complex media generates multiple light scattering controlled by the complex media, and a wavefront of the multiple-scattered light is controlled so that the wavefront indicates a predefined desired optical field.
